(19) United States
(12) Patent Application Publication
(10) Pub. No.: US 2021/0274227 A1
(43) Pub. Date: Sep. 2, 2021

(54) INFORMATION PROCESSING SYSTEM, INFORMATION PROCESSING APPARATUS, AND NON-TRANSITORY COMPUTER READABLE MEDIUM

(71) Applicant: FUJI XEROX CO., LTD., Tokyo (JP)

(72) Inventor: Takaki TSUCHIYA, Kanagawa (JP)

(73) Assignee: FUJI XEROX CO., LTD., Tokyo (JP)

(21) Appl. No.: 16/920,413

(22) Filed: Jul. 2, 2020

(30) Foreign Application Priority Data
Mar. 2, 2020 (JP) 2020-035370

(51) Int. Cl. H04N 21/2387; H04N 21/258; H04N 21/454

(52) U.S. Cl. CPC H04N 21/2387; H04N 21/454; H04N 21/25875

(57) ABSTRACT

An information processing system includes a processor. The processor is configured to acquire information included in a video and/or information attached to the video, determine, for each viewer who views the video, a permitted part of the video that the viewer is permitted to view, based on the acquired information, and generate, for the viewer, control information for causing the permitted part corresponding to the viewer to be played back.

### CROSS-REFERENCE TO RELATED APPLICATIONS

This application is based on and claims priority under 35 USC 119 from Japanese Patent Application No. 2020-035370 filed Mar. 2, 2020.

### BACKGROUND

### (i) Technical Field

The present disclosure relates to an information processing system, an information processing apparatus, and a non-transitory computer readable medium.

### (ii) Related Art

Japanese Patent No. 5773336 discloses a process for selecting, in a case where an event during play of a game satisfies a plurality of tagging conditions for the same condition target, one of a plurality of tags associated with the plurality of tagging conditions and attaching the selected tag to playback data.

### SUMMARY

Videos may contain content that is not desired to be disclosed to all viewers. In this case, it is desirable that content to be played back is different depending on the viewers who view a video.

To make content to be played back different depending on the viewers, for example, an editor may edit a video to prepare a plurality of videos in advance for individual viewers.

Aspects of non-limiting embodiments of the present disclosure relate to reducing a storage region for a video compared to the case where a plurality of videos are prepared in advance for individual viewers.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor. The processor is configured to acquire information included in a video and/or information attached to the video, determine, for each viewer who views the video, a permitted part of the video that the viewer is permitted to view, based on the acquired information, and generate, for the viewer, control information for causing the permitted part corresponding to the viewer to be played back.

### BRIEF DESCRIPTION OF THE DRAWINGS

Exemplary embodiments of the present disclosure will be described in detail based on the following figures, wherein:

FIG. 1 is a diagram illustrating an example of the configuration of an information processing system;

FIG. 2 is a flowchart illustrating the flow of a process for registering a video file performed by a content management server and the like;

FIG. 3 is a flowchart illustrating the flow of the process for registering a video file performed by the content management server and the like;

FIG. 4 is a diagram illustrating a specific example of the registration process;

FIG. 5 is a diagram illustrating a specific example of the registration process;

FIGS. 6A, 6B, 6C, and 6D are diagrams for explaining information attached to videos;

FIG. 7 is a diagram illustrating information stored in an access right determination information management database (DB);

FIG. 8 is a diagram illustrating a content information management DB;

FIG. 9 is a flowchart illustrating a process for displaying a list of files;

FIG. 10 is a flowchart illustrating the process for displaying a list of files;

FIG. 11 is a diagram for explaining a specific example of the process for displaying a list of files;

FIG. 12 is a diagram for explaining the specific example of the process for displaying a list of files;

FIGS. 13A and 13B are diagrams for explaining a screen displayed on a client terminal;

FIG. 14 is a flowchart illustrating the flow of a process for viewing a video file;

FIG. 15 is a flowchart illustrating the flow of the process for viewing a video file;

FIG. 16 is a flowchart illustrating the flow of the process for viewing a video file;

FIG. 17 is a flowchart illustrating the flow of the process for viewing a video file;

FIGS. 18A and 18B are diagrams illustrating screens displayed when a video file is viewed on the client terminal;

FIGS. 19A and 19B are diagrams illustrating screens displayed when a video file is viewed on the client terminal;

FIG. 20 is a diagram illustrating another example of display on the client terminal;

FIG. 21 is a flowchart illustrating another example of the process for registering a video file;

FIG. 22 is a flowchart illustrating the example of the process for registering a video file;

FIG. 23 is a diagram illustrating a specific example of a process for generating a thumbnail image and a thumbnail video;

FIG. 24 is a diagram illustrating an example of storage destination information stored in a video information management DB;

FIG. 25 is a flowchart illustrating the flow of a process for displaying a list of files;

FIG. 26 is a diagram illustrating a specific example of the process for displaying a list of files;

FIG. 27 is a diagram illustrating a screen displayed on a client terminal of a user who belongs to an X department group; and

FIG. 28 is a diagram for explaining an example of the hardware configuration of a content management server and a video analysis server.

### DETAILED DESCRIPTION

Hereinafter, exemplary embodiments of the present disclosure will be described in detail with reference to attached drawings.

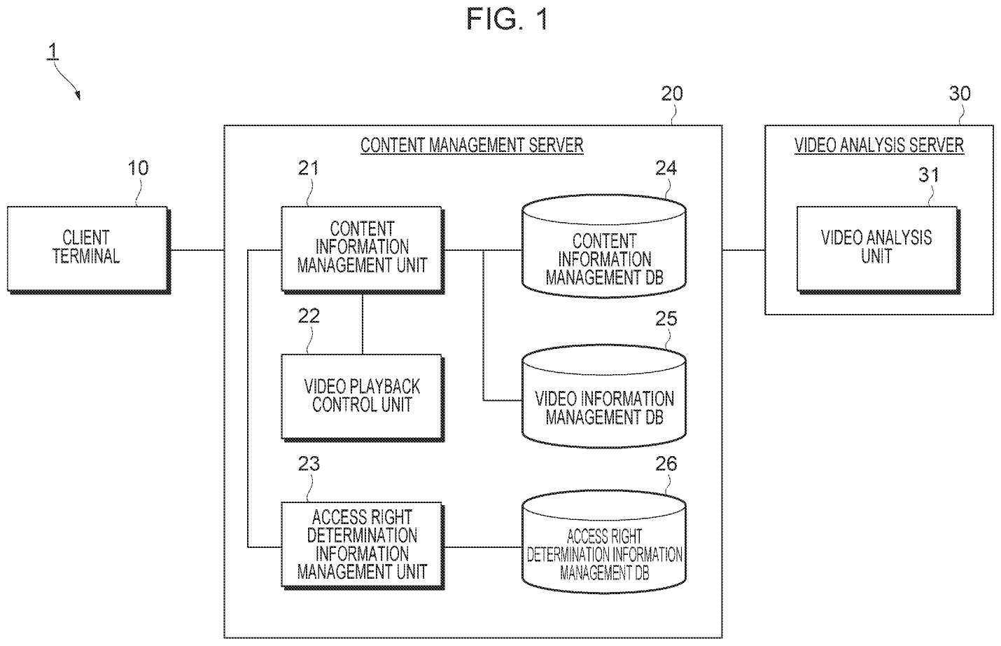

FIG. 1 is a diagram illustrating an example of the configuration of an information processing system 1 according to an exemplary embodiment.

The information processing system 1 according to this exemplary embodiment includes a client terminal 10, a content management server 20, and a video analysis server 30.

The client terminal 10 and the content management server 20 are connected to each other via a communication line such as an Internet line. The content management server 20 and the video analysis server 30 are also connected to each other via a communication line such as the Internet line.

In this exemplary embodiment, only one client terminal 10 is illustrated. However, a plurality of client terminals 10 may be provided. The client terminal 10 is, for example, a personal computer (PC) or a mobile terminal.

Furthermore, in this exemplary embodiment, the video analysis server 30 is provided independent of the content management server 20. However, the content management server 20 may include a function of the video analysis server 30.

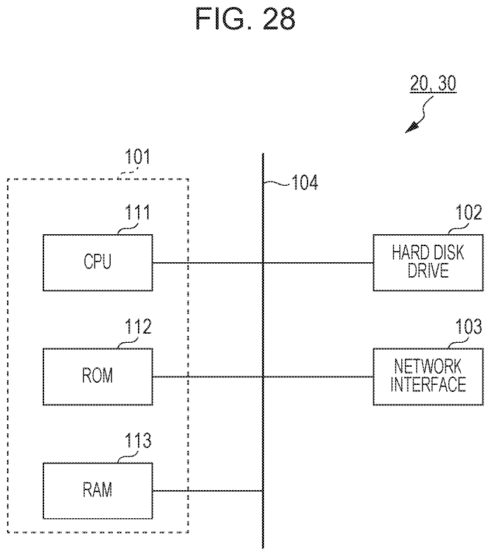

FIG. 28 is a diagram for explaining an example of the hardware configuration of the content management server 20 and the video analysis server 30.

The content management server 20 and the video analysis server 30 each include a control unit 101 that controls operation of the entire apparatus, a hard disk drive 102 that stores management data and the like, and a network interface 103 that implements communication via a local area network (LAN) a cable or the like.

The control unit 101 includes a central processing unit (CPU) 111, which is an example of a processor, a read only memory (ROM) 112 in which basic software, a basic input output system (BIOS), and the like are stored, and a random access memory (RAM) 113 that is used as a work area.

The CPU 111 may have multiple cores. The ROM 112 may be a rewritable nonvolatile semiconductor memory. The control unit 101 is a so-called computer.

The hard disk drive 102 is a device that writes and reads data to and from a nonvolatile storage medium. A magnetic substance is applied to the surface of a disc-shape substrate of the storage medium. The nonvolatile storage medium may be a semiconductor memory or a magnetic tape.

Furthermore, the content management server 20 and the video analysis server 30 each include, if necessary, an input device such as a keyboard, a mouse, and the like and a display device such as a liquid crystal display and the like.

The control unit 101, the hard disk drive 102, and the network interface 103 are connected to one another via a bus 104 or a signal line, which is not illustrated in FIG. 28.

A program to be executed by the CPU 111 may be stored in a computer-readable recording medium such as a magnetic recording medium (a magnetic tape, a magnetic disk, or the like), an optical recording medium (an optical disc or the like), a magneto-optical recording medium, or a semiconductor memory and provided to the content management server 20 and the video analysis server 30.

Furthermore, a program to be executed by the CPU 111 may be provided to the content management server 20 and the video analysis server 30 via communication means such as the Internet.

As illustrated in FIG. 1, the content management server 20, which is an example of an information processing apparatus, includes a content information management unit 21, a video playback control unit 22, an access right determination information management unit 23, a content information management database (DB) 24, a video information management DB 25, and an access right determination information management DB 26.

The content information management unit 21, the video playback control unit 22, and the access right determination information management unit 23 are implemented when the CPU 111 (see FIG. 28), which is an example of a processor, executes a program stored in the ROM 112 or the like.

In other words, in this exemplary embodiment, processes described later are performed by the content management server 20. However, these processes are performed by the CPU 111, which is an example of a processor, provided in the content management server 20.

Furthermore, the content information management DB 24, the video information management DB 25, and the access right determination information management DB 26 are implemented by the hard disk drive 102 provided in the content management server 20.

The content information management unit 21 receives requests for registration, acquisition, update, and deletion of content (a document file, a video file, and the like) from the client terminal 10, and acquires and updates information stored in the content information management DB 24.

The video playback control unit 22 generates control information for controlling playback of a video file at the client terminal 10.

The access right determination information management unit 23 determines, based on a result of analysis of a video file and information stored in the access right determination information management DB 26, a user group that is able to access the video file and a time period for which the video file is allowed to be played back.

The content information management DB 24 stores attributes of content (name, registered date and time, updated date and time, and the like) and access right information.

The video information management DB 25 manages information regarding storage destinations for a thumbnail image and the thumbnail image.

The access right determination information management DB 26 stores a keyword and information of a user group that is able to access a video file during a playback time period for which the keyword is extracted.

### Registration of Video File

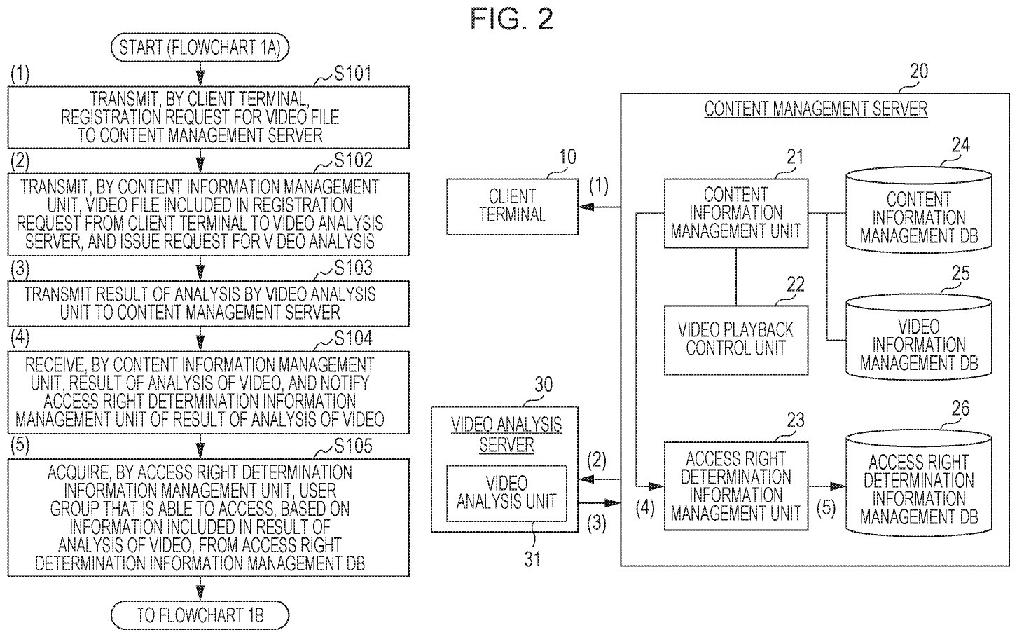

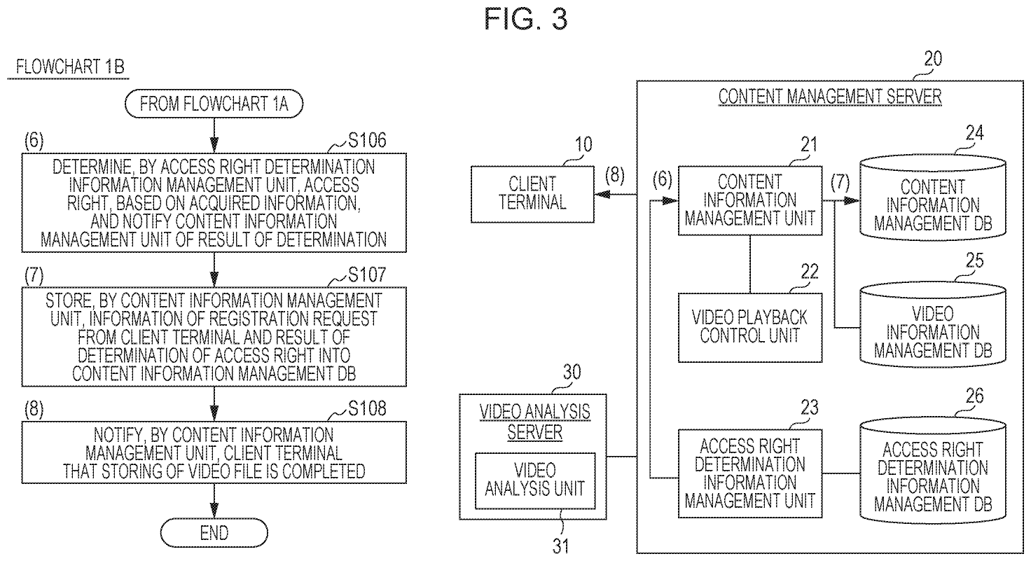

FIGS. 2 and 3 are flowcharts illustrating the flow of a process for registering a video file performed by the content management server 20 and the like.

In this exemplary embodiment, the client terminal 10 transmits a request to register a video file (hereinafter, referred to as a “registration request”) to the content management server 20 (step S101). This registration request contains a video file that a user wishes to register.

Next, the content management server 20 acquires the registration request.

Then, the content information management unit 21 of the content management server 20 acquires the video file included in the registration request.

Furthermore, the content information management unit 21 transmits the video file to the video analysis server 30, and requests the video analysis server 30 to analyze the video file (step S102).

The video analysis server 30 receives the video file. In the video analysis server 30, a video analysis unit 31 analyzes the video file. A result of the analysis obtained by the video analysis unit 31 is transmitted to the content management server 20 (step S103).

The content information management unit 21 receives the result of the analysis, which has been transmitted to the content management server 20. Next, the content information management unit 21 notifies the access right determination information management unit 23 of the result of the analysis (step S104).

The access right determination information management unit 23 obtains (acquires) a user group that is able to access the video file as a target for registration, based on the result of the analysis and information stored in the access right determination information management DB 26 (step S105).

Next, the access right determination information management unit 23 determines an access right, and notifies the content information management unit 21 of a result of the determination (step S106).

The content information management unit 21 stores information regarding the registration request from the client terminal 10 and the result of determination of the access right, which has been obtained by the access right determination information management unit 23, into the content information management DB 24 (step S107).

Next, the content information management unit 21 notifies the client terminal 10 that storing of the video file is completed (step S108).

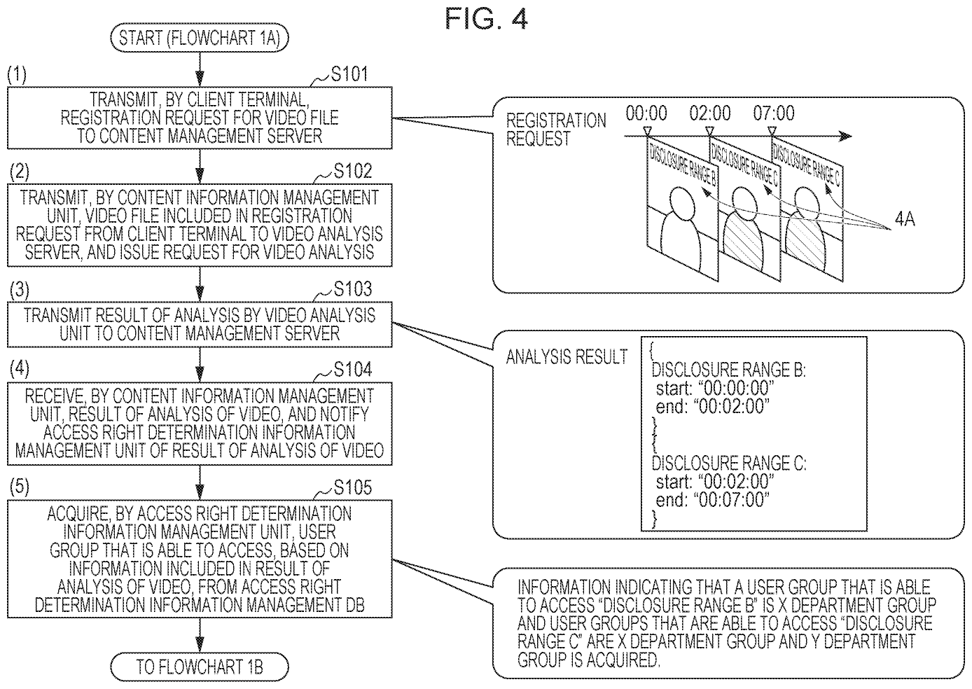

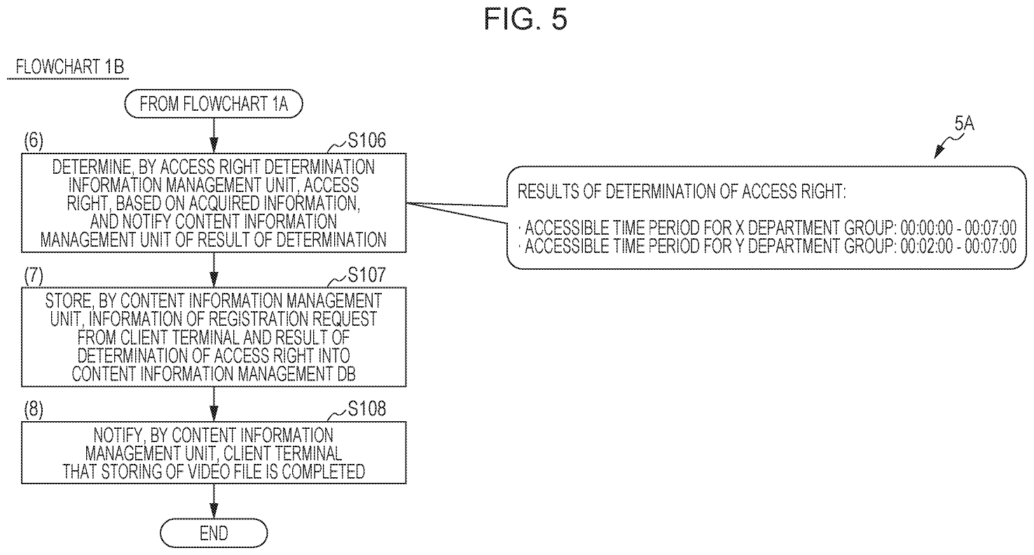

The process for registering a video file will be explained more specifically with reference to FIGS. 4 and 5 (diagrams illustrating a specific example of the registration process).

In this exemplary embodiment, metadata is attached to a video file as a target for registration, as indicated by sign 4A in FIG. 4. In this exemplary embodiment, a video file to which such metadata is attached is transmitted from the client terminal 10 to the content management server 20.

After that, in this exemplary embodiment, in step S103, the video file is analyzed. From this analysis, the metadata, which is information attached to the video file, is acquired.

More specifically, in this exemplary embodiment, range information, which is information indicating a range of eligible people who are permitted to view a video file, is attached as metadata to the video file. In the processing of step S103, the range information is acquired.

More specifically, in this example, a “disclosure range B” (see sign 4A), and a “disclosure range C” (see sign 4A) are acquired as range information.

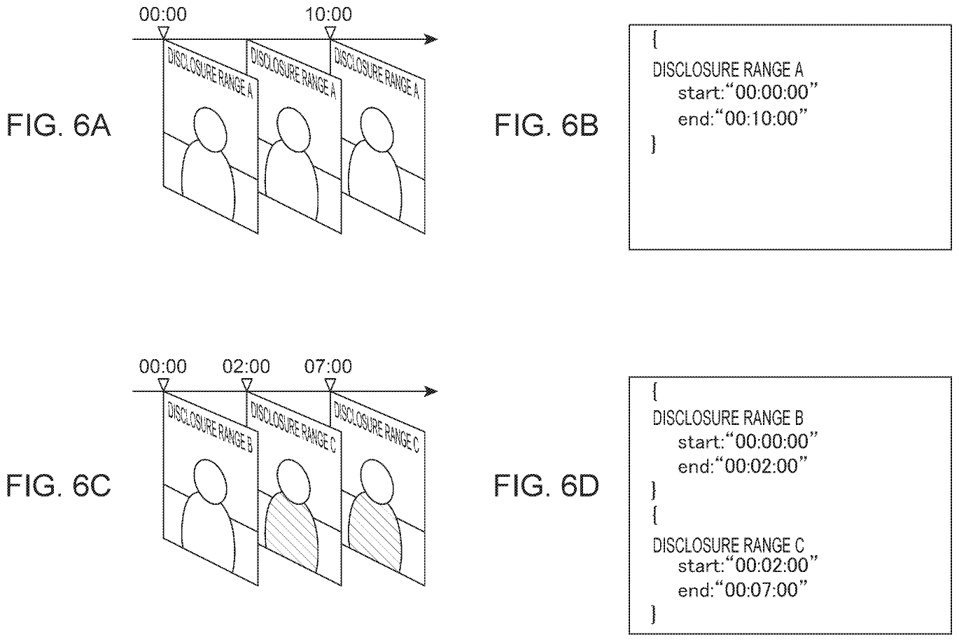

The details of acquisition of metadata will be described in detail with reference to FIGS. 6A, 6B, 6C, and 6D (diagrams for explaining information attached to a video file).

FIG. 6A illustrates a video file with a playback time of ten minutes in which range information “disclosure range A” is displayed for the whole time period of the video file (a video file in which the range information “disclosure range A” is attached to the whole time period from the start time to the end time) (hereinafter, referred to as “video file 1”).

In the case where the video file 1 is registered in the content management server 20, the information “disclosure range A” is acquired as range information of the video file 1, as illustrated in FIG. 6B.

Furthermore, in this exemplary embodiment, information indicating that the range information “disclosure range A” is associated with a time period “playback time, from 00:00:00 to 00:10:00” is acquired.

FIG. 6C illustrates a video file with a playback time of seven minutes in which range information “disclosure range B” is displayed for a time period from the beginning until two minutes have passed from the beginning and range information “disclosure range C” is displayed for a time period from the time when two minutes have passed from the beginning until the ending (hereinafter, referred to as “video file 2”).

In the case where the video file 2 is registered in the content management server 20, information “disclosure range B” and “disclosure range C” is acquired as range information of the video file 2, as illustrated in FIG. 6D.

Furthermore, information indicating that the information “disclosure range B” is associated with a time period “playback time, from 00:00:00 to 00:02:00” is acquired.

Moreover, information indicating that the information “disclosure range C” is associated with a time period “playback time, from 00:02:00 to 00:07:00” is acquired.

Referring back to FIG. 4, a case where the video file 2 is registered is illustrated in FIG. 4. In the processing of step S103, “disclosure range B” and “disclosure range C” are acquired as range information.

Furthermore, in the processing of step S103, information indicating that the range information “disclosure range B” is associated with the time period “playback time, from 00:00:00 to 00:02:00” is acquired.

Moreover, in the processing of step S103, information indicating that the range information “disclosure range C” is associated with the time period “playback time, from 00:02:00 to 00:07:00” is acquired.

Then, in this exemplary embodiment, in step S105, the access right determination information management unit 23 acquires information of a user group that is able to access the video file 2 (hereinafter, referred to as “user group information”), in accordance with a result of analysis of the video file 2 (a result of analysis acquired by the video analysis server 30) and information stored in the access right determination information management DB 26.

More specifically, the access right determination information management unit 23 acquires information indicating that a user group that is able to access a part of the video file 2 to which the range information “disclosure range B” is attached is an X department group.

Furthermore, the access right determination information management unit 23 acquires information indicating that user groups that are able to access a part of the video file 2 to which the range information “disclosure range C” is attached are the X department group and a Y department group.

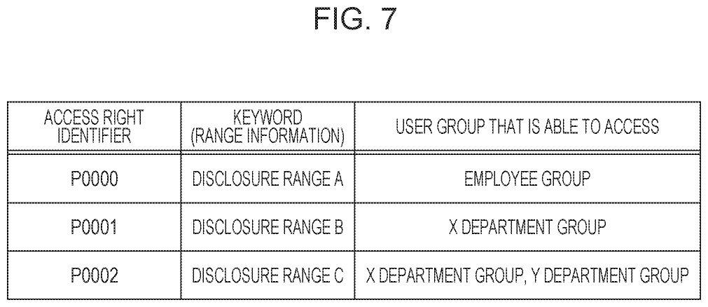

FIG. 7 is a diagram illustrating information stored in the access right determination information management DB 26.

A user group that is permitted to access (view) a part of a video file to which a keyword (range information) is attached is registered in the access right determination information management DB 26.

More specifically, in this example, an employee group (all employees) is registered in association with the disclosure range A, the X department group is registered in association with the disclosure range B, and the X department group and the Y department group are registered in association with the disclosure range C.

In the processing (processing for acquiring a user group) of step S105 (see FIG. 4) described above, the access right determination information management unit 23 refers to the information stored in the access right determination information management DB 26, and acquires the X department group as one of user groups that are able to access the video file 2.

More specifically, the access right determination information management unit 23 acquires information indicating that a user group that is able to access a part of the video file 2 with which the range information “disclosure range B” is associated is the X department group.

Furthermore, the access right determination information management unit 23 refers to the information stored in the access right determination information management DB 26, and acquires the X department group and the Y department group as user groups that are able to access the video file 2.

More specifically, the access right determination information management unit 23 acquires information indicating that user groups that are able to access a part of the video file 2 with which the range information “disclosure range C” is associated are the X department group and the Y department group.

Accordingly, the access right determination information management unit 23 learns, based on the information stored in the access right determination information management DB 26, that the user group that is able to access the part to which the range information “disclosure range B” is attached is the X department group.

Furthermore, the access right determination information management unit 23 learns, based on the information stored in the access right determination information management DB 26, that the user groups that are able to access the part to which the range information “disclosure range C” is attached are the X department group and the Y department group.

In this exemplary embodiment, information attached to a video file is acquired. However, information attached to a video file is not necessarily acquired. Information included in a video file may be acquired by analyzing the content in the video file, and the information included in the video file may be acquired as range information.

More specifically, for example, by analyzing the content in a video file, information of people who appear in the video file may be acquired as information included in the video file, and information of each person who appears in the video file may be acquired as range information.

In this case, information of a person who may appear in a video file is registered in advance in the access right determination information management DB 26, and a user group that is able to access the video file is registered for each person in the access right determination information management DB 26.

Thus, in this case, the access right determination information management unit 23 learns, based on range information (information of a person who appears in a video file) acquired by analyzing the content in the video file and range information and information of a user group that are stored in the access right determination information management DB 26, a user group that is able to access a part of the video file to which the range information is attached.

Next, in this exemplary embodiment, in step S106 of FIG. 5, the access right determination information management unit 23 determines an access right on the basis of the information acquired by the processing described above, and acquires information of a time period for which each user group is able to access the video file.

Specifically, in this example, as indicated by sign 5A in FIG. 5, the access right determination information management unit 23 acquires information indicating that the time period for which a user in the X department group is able to access the video file is “playback time, from 00:00:00 to 00:07:00”.

Furthermore, the access right determination information management unit 23 acquires information indicating that the time period for which a user in the Y department group is able to access the video file is “playback time, from 00:02:00 to 00:07:00”.

In this exemplary embodiment, “playback time, from 00:00:00 to 00:07:00” and “playback time, from 00:02:00 to 00:07:00” are permitted parts, which are parts of the video file that viewers are permitted to view.

In this exemplary embodiment, in step S106, a permitted part, which is a part of the video file that a viewer who views the video is permitted to view, is determined on the basis of the information acquired before the processing of step S106.

More specifically, in this exemplary embodiment, as described above, as information attached to the video file, range information, which is information indicating the range of eligible people who are permitted to view the video file, is acquired.

In this exemplary embodiment, a permitted part for a viewer who views the video file is determined based on the acquired range information and viewer information, which is information of the viewer.

More specifically, in this exemplary embodiment, an associated part, which is a part of the video file that is associated with range information, is obtained.

Specifically, in this exemplary embodiment, as described above, for example, an associated part “playback time, from 00:00:00 to 00:02:00” is obtained as an associated part with which the range information “disclosure range B” is associated.

Furthermore, in this exemplary embodiment, for example, an associated part “playback time, from 00:02:00 to 00:07:00” is obtained as an associated part with which the range information “disclosure range C” is associated.

Moreover, in this exemplary embodiment, based on a range identified by range information and a viewer identified by viewer information, range information indicating a range to which the viewer belongs is identified.

More specifically, in this exemplary embodiment, the range information “disclosure range B” and “disclosure range C” is acquired. Based on the range information and the information stored in the access right determination information management DB 26, range information to which each user group belongs is identified.

Thus, in this exemplary embodiment, an associated part of the video file with which the identified range information is associated is set as a permitted part.

Then, in this exemplary embodiment, in step S107 (see FIG. 5), the content information management unit 21 registers (stores) the result of the determination obtained in step S106 and information of the registration request transmitted from the client terminal 10 into the content information management DB 24.

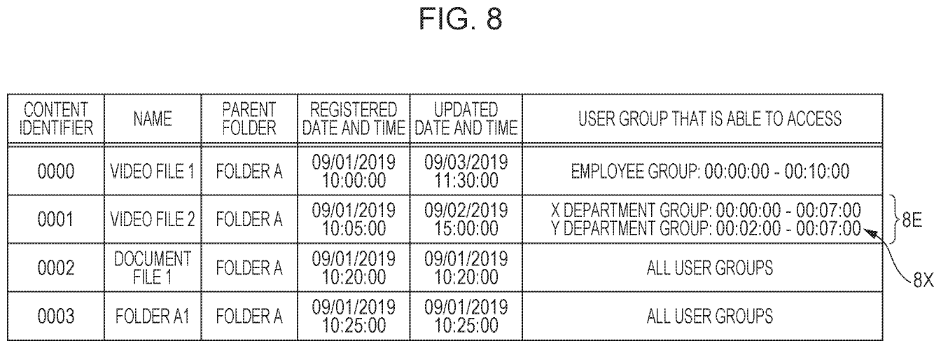

When the determination result is registered in the content information management DB 24, information indicating that the time period for which a user in the X department group is able to access the video file is “playback time, from 00:00:00 to 00:07:00” is registered, as indicated by sign 8E in FIG. 8 (a diagram illustrating the content information management DB 24).

Furthermore, information indicating that the time period for which an employee in the Y department group is able to access the video file is “playback time, from 00:02:00 to 00:07:00” is registered.

In other words, in this exemplary embodiment, when the determination result is registered in the content information management DB 24, information indicating that the permitted part for a user in the X department group is “playback time, from 00:00:00 to 00:07:00” is registered.

Furthermore, in this exemplary embodiment, when the determination result is registered in the content information management DB 24, information indicating that the permitted part for a user in the Y department group is “playback time, from 00:02:00 to 00:07:00” is registered.

### List of Files

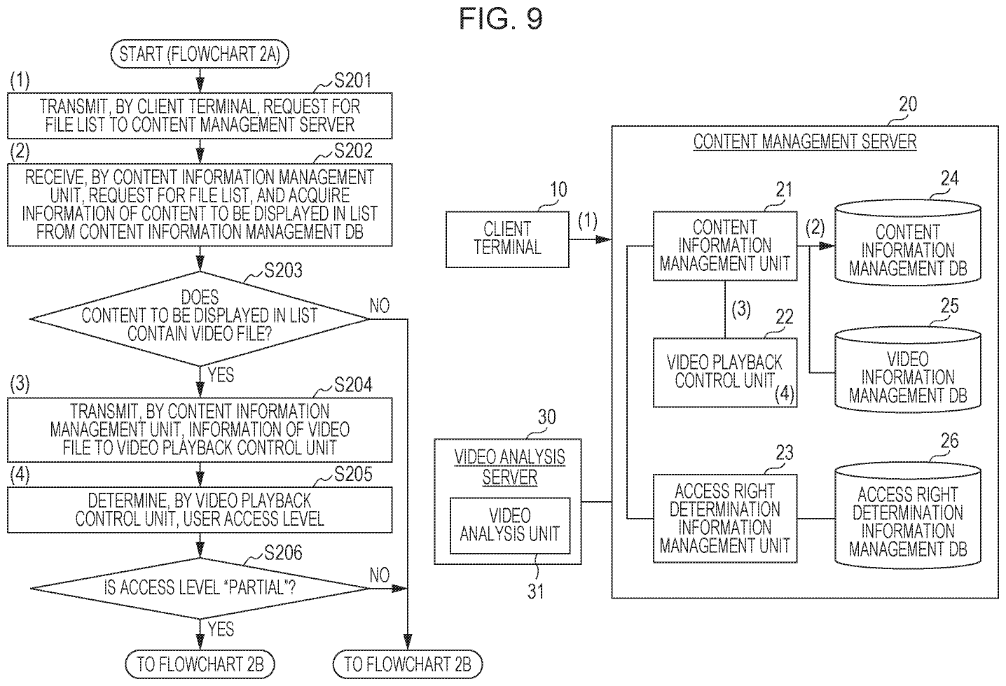

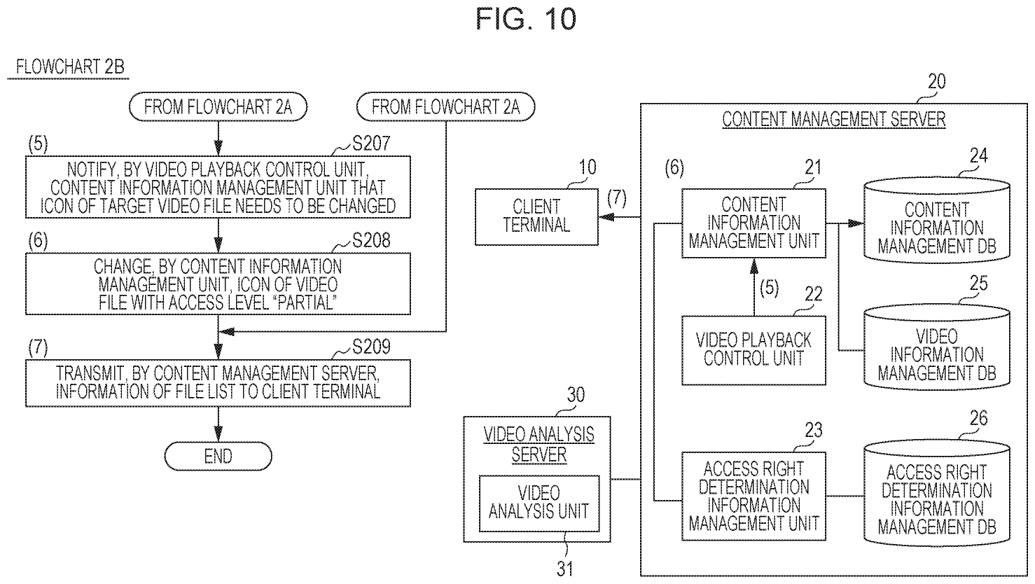

FIGS. 9 and 10 are flowcharts illustrating a process for displaying a list of files. The process for displaying a list of files performed by the client terminal 10 will be described with reference to FIGS. 9 and 10.

To display a list of files (hereinafter, referred to as a “file list”) on the client terminal 10, for example, the client terminal 10 transmits a request for a file list to the content management server 20 in accordance with an instruction from a user (step S201).

In this exemplary embodiment, the content information management unit 21 receives the request for the file list, and acquires information of content to be displayed in the list from the content information management DB 24 (step S202).

Next, the content information management unit 21 determines whether the content to be displayed in the list contains a video file (step S203).

More specifically, the content information management unit 21 determines, based on the information of the content acquired from the content information management DB 24, whether the content to be displayed in the list contains a video file.

In the case where it is determined in step S203 that the content to be displayed in the list contains no video file, the process proceeds to step S209.

In contrast, in the case where it is determined that the content to be displayed in the list contains a video file, the content information management unit 21 transmits information of each video file to the video playback control unit 22 (step S204).

The video playback control unit 22 determines user access level, based on the information of the video file (step S205).

More specifically, the video playback control unit 22 determines, for each video file, whether user access level represents “partial” (step S206).

In the case where it is determined in step S206 that the access level does not represent “partial” (in the case where there is no video file with an access level of “partial”), the process proceeds to step S209.

In contrast, in the case where it is determined in step S206 that the access level represents “partial” (in the case where there is a video file with an access level of “partial”), the video playback control unit 22 notifies the content information management unit 21 that an icon of the video file with the access level determined to be “partial” needs to be changed (step S207).

In accordance with the notification, the content information management unit 21 changes the icon indicating the video file with the access level determined to be “partial” (step S208).

In other words, the icon may be regarded as an image corresponding to a video, which is an image corresponding to a video file. The content information management unit 21 changes the image corresponding to a video representing the video file with the access level determined to be “partial” into a different image corresponding to a video.

Next, the content management server 20 transmits information of the file list to the client terminal 10 (step S209).

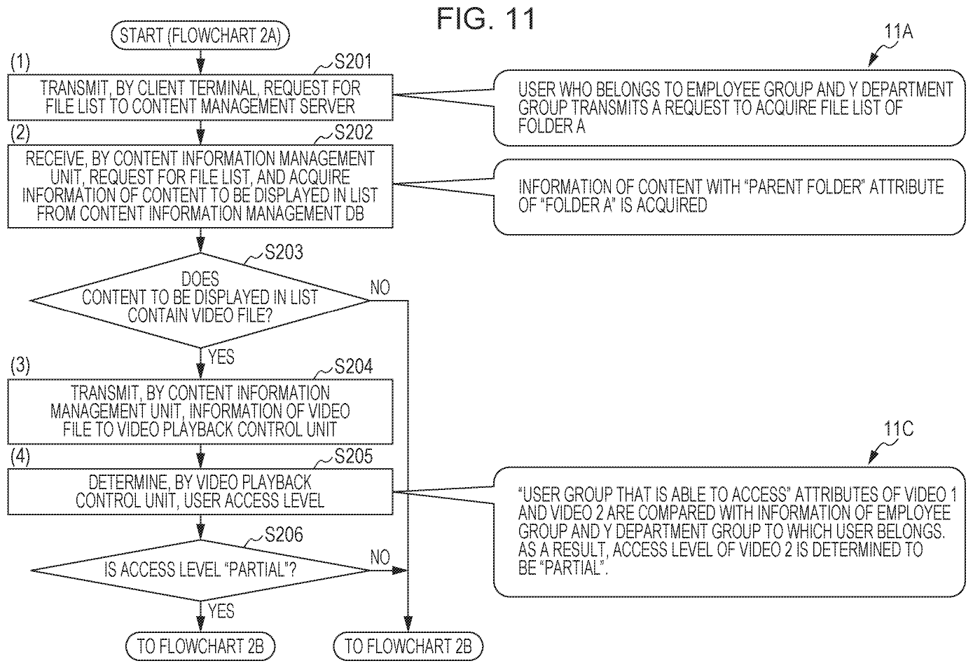

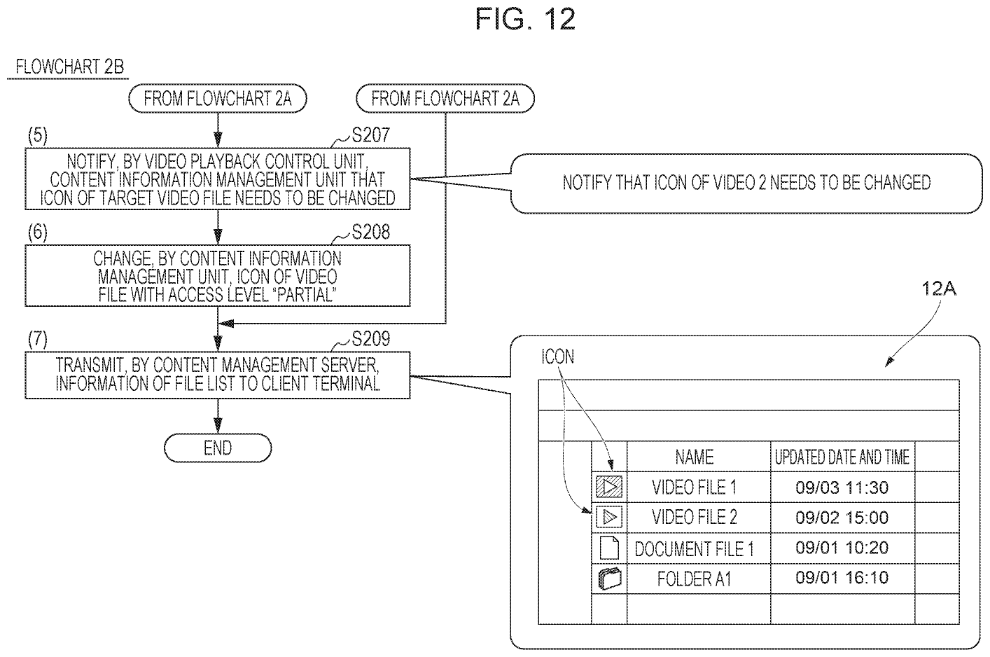

More specifically, with reference to FIGS. 11 and 12 (diagrams for explaining a specific example of the process for displaying a file list), in this exemplary embodiment, in step S201, the client terminal 10 transmits a request for a file list to the content management server 20.

In this example, as indicated by sign 11A in FIG. 11, a case where a user who belongs to the employee group and the Y department group transmits a request to acquire a file list of a folder A will be described.

In this case, in step S202, the content information management unit 21 receives the request for the file list, and acquires information of content to be displayed in the list from the content information management DB 24.

In this example, the content information management unit 21 acquires information of content whose “parent folder” attribute is “folder A” from the content information management DB 24 (see FIG. 8).

Then, in this example, in step S203, it is determined that the content to be displayed in the list contains a video file. In step S204, the content information management unit 21 transmits information of each video file to the video playback control unit 22.

More specifically, the content information management unit 21 transmits information of the video file 1 and the video file 2 whose “parent folder” attribute is the “folder A” to the video playback control unit 22.

Then, in this exemplary embodiment, in step S205, the video playback control unit 22 determines, based on the information transmitted from the content information management unit 21, user access level for each video file.

In this example, the video playback control unit 22 determines user access level for each of the video file 1 and the video file 2.

Specifically, the video playback control unit 22 determines, based on information of a “user group that is able to access” stored in the content information management DB 24 (see FIG. 8) and information of a user who wishes the file list to be displayed (a user who belongs to the employee group and the Y department group), whether the access level of each of the video file 1 and the video file 2 represents “partial”.

In this case, the video playback control unit 22 determines that the access level of the video file 2 represents “partial”, as indicated by sign 11C in FIG. 11.

More specifically, in this example, as indicated by sign 8X in FIG. 8, a user who belongs to the Y department group is able to view only the video file 2. Thus, the video playback control unit 22 determines that the access level of the video file 2 represents “partial”.

In this case, in this exemplary embodiment, in step S207 (see FIG. 12), the video playback control unit 22 notifies the content information management unit 21 that an icon of the target video file (video file 2) needs to be changed.

In this case, in step S208, the content information management unit 21 changes the icon indicating the video file 2. In other words, the content information management unit 21 changes an image corresponding to a video representing the video file 2 with the access level of “partial”.

Next, in this exemplary embodiment, in step S209, the content management server 20 transmits information of the file list to the client terminal 10.

In this case, on the client terminal 10, as indicated by sign 12A in FIG. 12, for example, the icon of the video file 2 is displayed in blue, which is a different color than the color of the icon of the video file 1 (for example, red).

In this case, by referring to the icon, the user is able to know that viewing of the video file 2 is partially restricted.

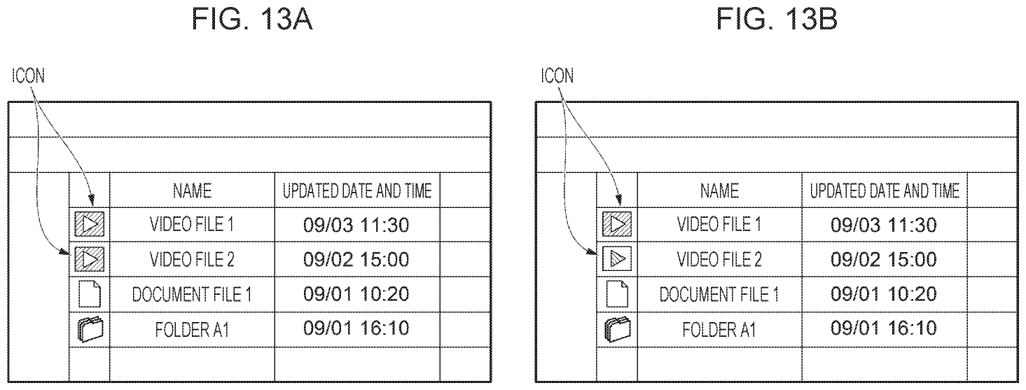

FIGS. 13A and 13B are diagrams for explaining a screen displayed on the client terminal 10. More specifically, FIGS. 13A and 13B are diagrams illustrating a display screen on which a file list is displayed.

In this exemplary embodiment, as described above, in the case where a user who wishes a file list to be displayed belongs to the Y department group, it is determined that the user is able to partially access the video file 2.

In this case, as illustrated in FIG. 13B, the icon of the video file 2 is displayed in a manner different from the icon of the video file 1.

In contrast, for example, in the case where a user who wishes the list to be displayed belongs to the X department group, the user is able to access the whole video file 2, not part of the video file 2.

In this case, as illustrated in FIG. 13A, the icon of the video file 2 is displayed as the same icon as the icon indicating the video file 1.

In this exemplary embodiment, an icon of a video file that is determined to be fully accessible, not partially accessible, is displayed in, for example, red.

All the employees (all users) are able to access the whole video file 1, and there is no restriction in accessing the video file 1. Therefore, the icon of the video file 1 is displayed in red.

In the case where a user who wishes the file list to be displayed belongs to the Y department group, the user is restricted in access to the video file 2 (a permitted part of the video file that the user is permitted to view is part of the video file). Thus, the icon of the video file 2 is displayed in blue.

In contrast, in the case where a user who wishes the file list to be displayed belongs to the X department group, the user is not restricted in access to the video file 2 (the whole time period of the video file corresponds to a permitted part). Thus, the icon of the video file 2 is displayed in red.

In this exemplary embodiment, when a request to display a list of files is issued, a screen to be displayed on the client terminal 10, a content list being displayed on the screen, is generated by the content management server 20.

In other words, the content management server 20 generates a screen to be viewed by a viewer. In the case where content contains a video file, a screen on which an icon as an example of an image corresponding to a video, which is an image corresponding to the video file, is displayed is generated.

In this exemplary embodiment, for generation of the screen, a different image corresponding to a video is generated according to the length of a permitted part of a video file.

More specifically, in this exemplary embodiment, for generation of a screen on which an image corresponding to a video that corresponds to a video file in which part of the whole time period of the video file is defined as a permitted part, as in the video file 2, is displayed, the image corresponding to the video is displayed in a first display state, for example, displayed in blue, as described above.

In contrast, for generation of a screen on which an image corresponding to a video that corresponds to a video file in which the whole time period of the video file is defined as a permitted part is displayed, the image corresponding to the video is displayed in a second display state, which is different from the first display state, for example, displayed in red, as described above.

In this exemplary embodiment, the case where different images corresponding to videos are displayed by being displayed in different colors is explained above. However, different colors are not necessarily used. For example, images corresponding to videos may have different shapes. For example, images corresponding to videos may have different sizes.

In addition, information indicating that viewing of a video file is partially restricted, such as a message “viewing is partially restricted”, may be displayed in association with an image corresponding to a video.

### Viewing of Video File

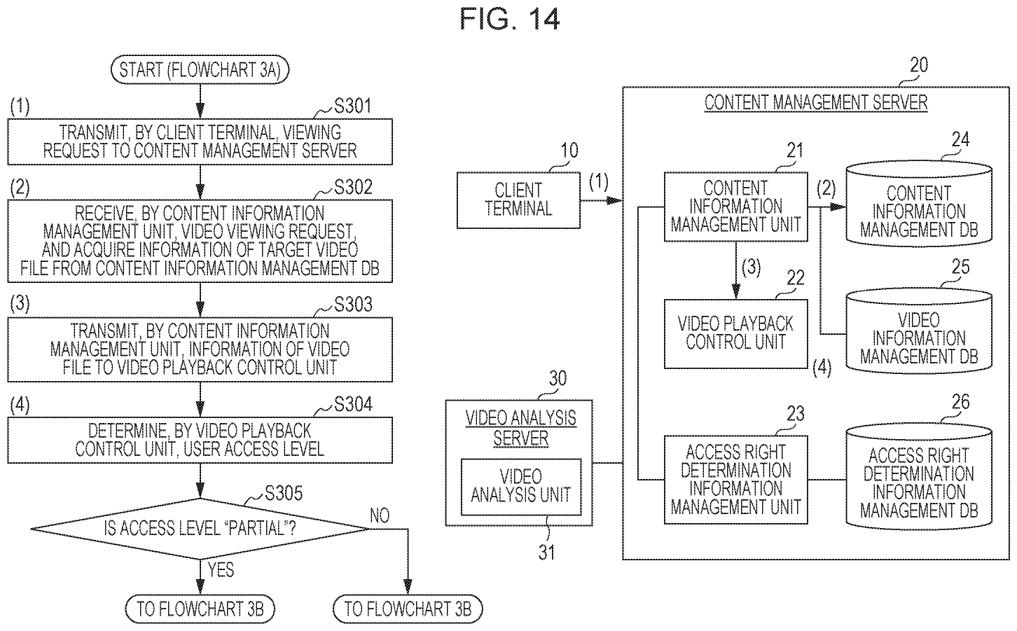

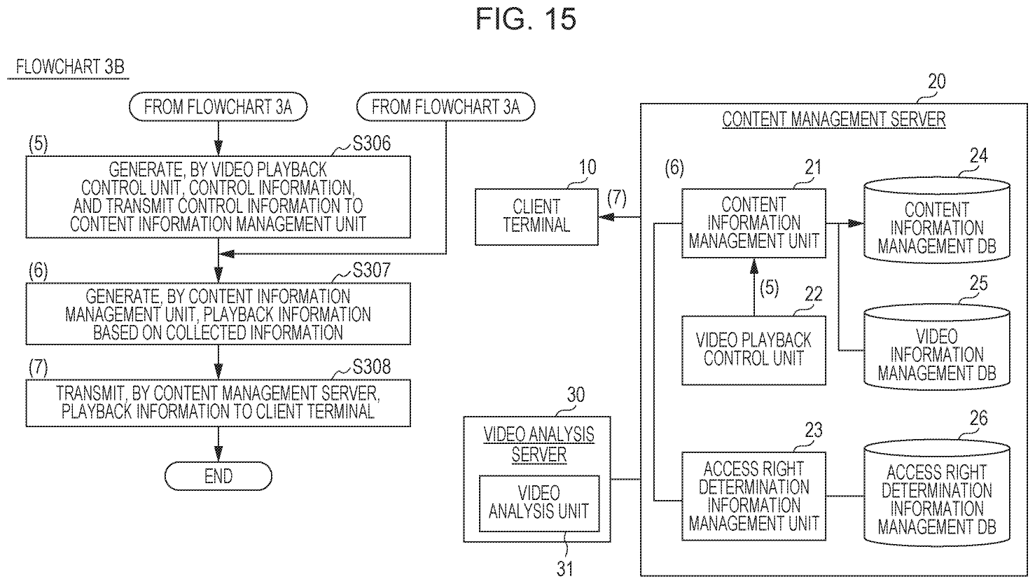

FIGS. 14 to 17 are flowcharts illustrating a process for viewing a video file.

The process for viewing a video file by a user will be described below with reference to FIGS. 14 to 17. In other words, a process for viewing, on the client terminal 10, a video file registered in the content management server 20 will be described.

To view a video file, the client terminal 10 transmits a request for viewing a video file to the content management server 20 (step S301).

More specifically, in this exemplary embodiment, for example, when an icon indicating a video file displayed on a display screen illustrated in FIG. 13(B) is selected, the client terminal 10 transmits a request for viewing the video file to the content management server 20.

Next, the content information management unit 21 receives the request for viewing the video file, and acquires information of the video file for which the request for viewing is issued from the content information management DB 24 (step S302).

Then, the content information management unit 21 transmits the information of the video file to the video playback control unit 22 (step S303).

Next, the video playback control unit 22 determines user access level, based on the information transmitted from the content information management unit 21 (step S304).

The video playback control unit 22 determines whether the access level represents “partial” (step S305).

In the case where it is determined that the access level does not represent “partial”, the process proceeds to step S307.

In contrast, in the case where it is determined that the access level represents “partial”, the video playback control unit 22 generates control information for controlling playback of the video file, and transmits the generated control information to the content information management unit 21 (step S306).

The content information management unit 21 generates playback information, based on the acquired information (in the case where the processing of step S306 is performed, information including the control information transmitted from the video playback control unit 22) (step S307).

The content management server 20 transmits the playback information to the client terminal 10 (step S308). Accordingly, the client terminal 10 plays back the video file that the user wishes to view.

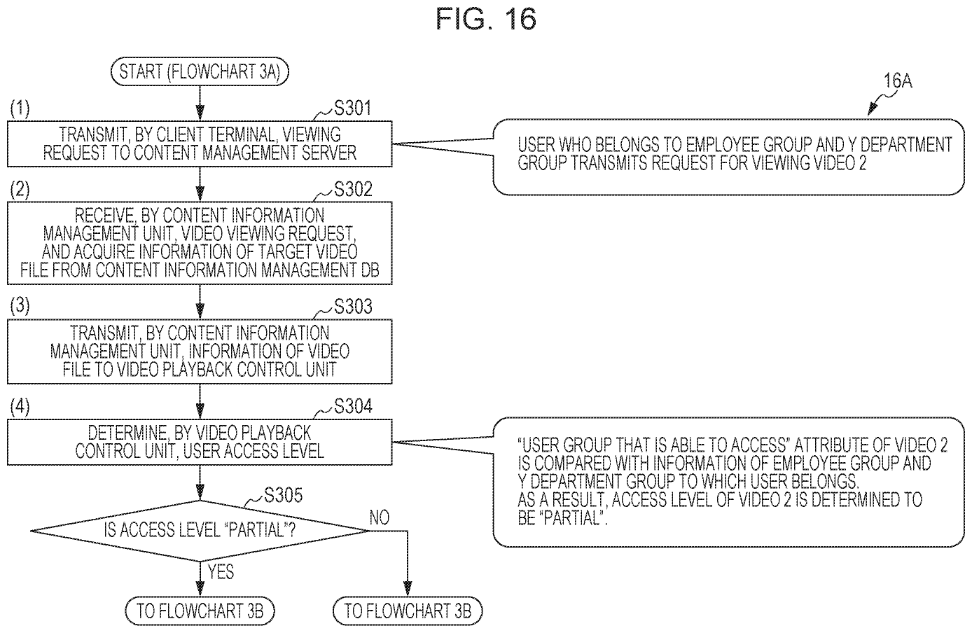

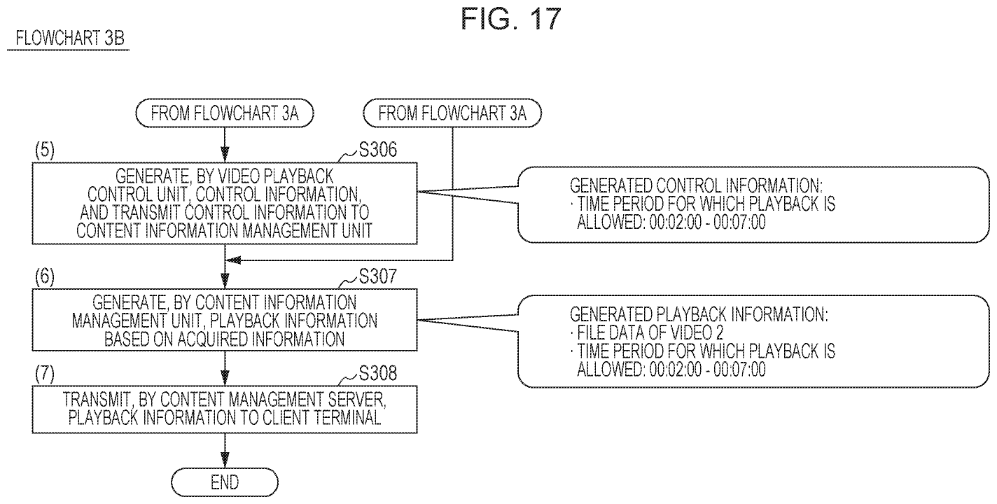

More specifically, with reference to FIGS. 16 and 17, in this exemplary embodiment, in step S301, as described above, the client terminal 10 transmits a request for viewing a video file to the content management server 20.

In the example illustrated in FIG. 16, as indicated by sign 16A, a case where a user who belongs to the employee group and the Y department group selects the video file 2 and a request for viewing the video file 2 is transmitted to the content management server 20 will be described.

Next, in this case, as described above, in step S302, the content information management unit 21 receives the request for viewing, and acquires information of the video file 2 that the user wishes to view from the content information management DB 24.

In step S303, the content information management unit 21 transmits the information of the video file 2 to the video playback control unit 22.

In step S304, the video playback control unit 22 determines the access level of the video file 2, based on the information of the video file 2 and information of the user who wishes to view the video file 2.

More specifically, the video playback control unit 22 determines the access level of the video file 2, based on the information of the video file 2 and information indicating that the user belongs to the Y department group.

Specifically, in this case, the video playback control unit 22 determines the access level of the video file 2, based on the information registered in the content information management DB 24 (see FIG. 8) and the information indicating that the user belongs to the Y department group.

More specifically, the video playback control unit 22 determines the access level of the video file 2, based on information of a user group that is able to access, which is registered in the rightmost field of the content information management DB 24 (see FIG. 8), and the information indicating the Y department group.

In this exemplary embodiment, in this case, the user who belongs to the Y department group is able to view only part (“00:02:00 to 00:07:00”) of the video file 2. Thus, the video playback control unit 22 determines that the access level of the video file 2 is “partial”.

Next, in this case, in this exemplary embodiment, in step S306 (see FIG. 17), the video playback control unit 22 generates control information for controlling playback of the video file 2, and transmits the control information to the content information management unit 21.

Specifically, in this case, the video playback control unit 22 generates, as control information for controlling playback of the video file 2, the following control information:

“Time period for which playback is allowed: 00:02:00 to 00:07:00”

Next, in this exemplary embodiment, in step S307, the content information management unit 21 generates playback information including the generated control information.

Specifically, in this example, the content information management unit 21 generates, for example, playback information including the following two pieces of information:

“file data of video file 2; and time period for which playback is allowed: 00:02:00 to 00:07:00”.

Accordingly, in this exemplary embodiment, a time period “00:02:00 to 00:07:00”, which is part of the video file 2, is played back on the client terminal 10. Additionally, a part of the video file 2 that is a permitted part that is allowed to be viewed, is played back.

In this exemplary embodiment, as described above, the content management server 20 sets a permitted part, which is a part that is permitted to be viewed, for each viewer who views a video file.

In this exemplary embodiment, as described above, for each viewer who views a video file, control information for causing a permitted part corresponding to the viewer to be played back is generated.

In other words, in this exemplary embodiment, for each viewer, control information for causing a permitted part corresponding to the viewer to be played back and causing a non-permitted part that is a part other than the permitted part not to be played back is generated.

In this exemplary embodiment, playback information including the control information is transmitted to the client terminal 10 (step S308).

In this case, playback of the video file 2 on the client terminal 10 is performed based on the control information included in the playback information, and only the permitted part of the video file 2 is thus played back.

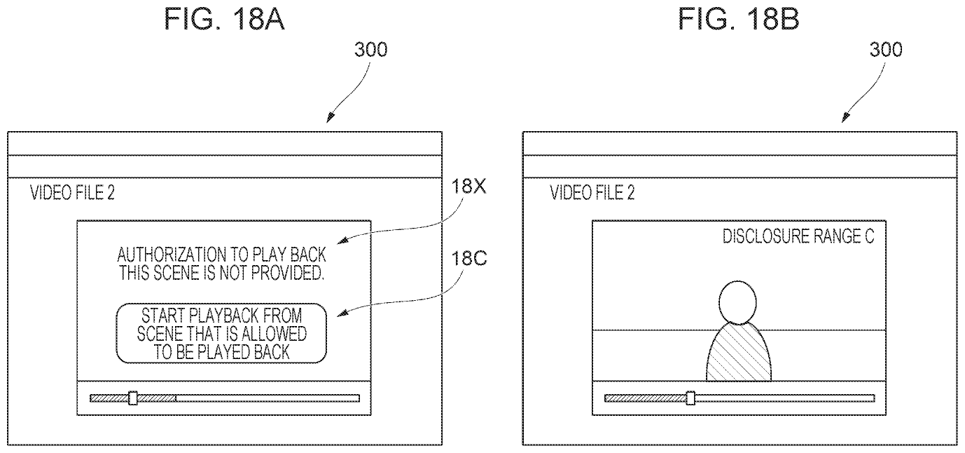

FIGS. 18(A) and 18(B) are diagrams illustrating screens displayed when the video file 2 is viewed on the client terminal 10.

As described above, in the case where a user who belongs to the employee group and the Y department group views the video file 2, the period time for which the video file 2 is allowed be played back on the client terminal 10 is from 00:02:00 to 00:07:00.

In this case, as illustrated in FIG. 18A, the video file is not able to be viewed during a part (from 00:00:00 to 00:02:00) of the whole time period of the video file.

In other words, in this exemplary embodiment, only a permitted part of the video file 2 is displayed on a display device 300 of the client terminal 10 (see FIGS. 18A and 18B), and a non-permitted part, which is other than the permitted part, is not able to be viewed.

Furthermore, in this exemplary embodiment, information indicating that part of the video file 2 will not be displayed is displayed on the display device 300.

More specifically, in this exemplary embodiment, as information indicating that part of the video file 2 will not be displayed, as indicated by sign 18X, information indicating that authorization to play back the video file is not provided is displayed.

More specifically, in this exemplary embodiment, in the case where a permitted part is a part of the video file, control information for causing information indicating that part of the video will not be displayed to be displayed on the display device 300 is generated by the content management server 20.

In other words, control information for causing information indicating that playback of the video file is not allowed to be displayed on the display device 300 is generated by the content management server 20.

Accordingly, in this exemplary embodiment, information indicating that playback of the video file is not allowed, such as information indicating that authorization to play back the video file is not provided, is displayed on the display device 300 of the client terminal 10.

FIGS. 18A and 18B illustrate a case where playback of the video file is performed in accordance with a manual instruction from a user.

In this exemplary embodiment, a message is displayed on the client terminal 10, as illustrated in FIG. 18A, during a time period for which the video file is not able to be viewed. Specifically, in this exemplary embodiment, information indicating that authorization to play back the video file is not provided is displayed.

In the example illustrated in FIGS. 18A and 18B, a viewer is able to request playback of a non-permitted part, which is other than a permitted part, of a video.

Specifically, when a user operates the client terminal 10, a viewer is able to request playback of a non-permitted part.

In this case, in this exemplary embodiment, when playback of a non-permitted part is requested by a viewer, information indicating that authorization to play back a video file is not provided is displayed, as illustrated in FIG. 18A.

More specifically, in this exemplary embodiment, the content management server 20 generates display control information for causing predetermined information to be displayed on the display device 300 in the case where playback of a non-permitted part of a video file is requested by a viewer.

More specifically, in this exemplary embodiment, the content management server 20 generates display control information for causing information indicating that authorization to play back a video file is not provided to be displayed on the display device 300.

In other words, the content management server 20 generates display control information for causing information indicating that a viewer does not have an authorization to play back a non-permitted part to be displayed on the display device 300.

Information indicating that authorization to play back a video file is not provided may be constantly displayed on the client terminal 10 or may by displayed when playback of a non-permitted part is requested by a viewer.

In other words, as display control information, display control information for causing information indicating that authorization to play back a video file is not provided (hereinafter, referred to as “non-authorization information”) to be constantly displayed may be generated, or display control information for causing non-authorization information to be displayed when playback of a non-permitted part is requested by a viewer.

In the case where the display control information for causing non-authorization information to be displayed when playback of a non-permitted part is requested by a viewer is generated, when playback of a non-permitted part is requested by a viewer, the non-authorization information displayed.

Furthermore, in this exemplary embodiment, during a time period for which a video file is not able to be viewed, as indicated by sign 18C in FIG. 18A, a message for confirming whether or not to skip to a time period for which the video file is able to be viewed is displayed.

In other words, in this exemplary embodiment, display for receiving from a user an instruction to start playback from the time period for which viewing is permitted is performed.

In this exemplary embodiment, when an instruction to start playback from a time period for which viewing is permitted is received from a user, as illustrated in FIG. 18B, playback from the time period for which viewing is permitted starts.

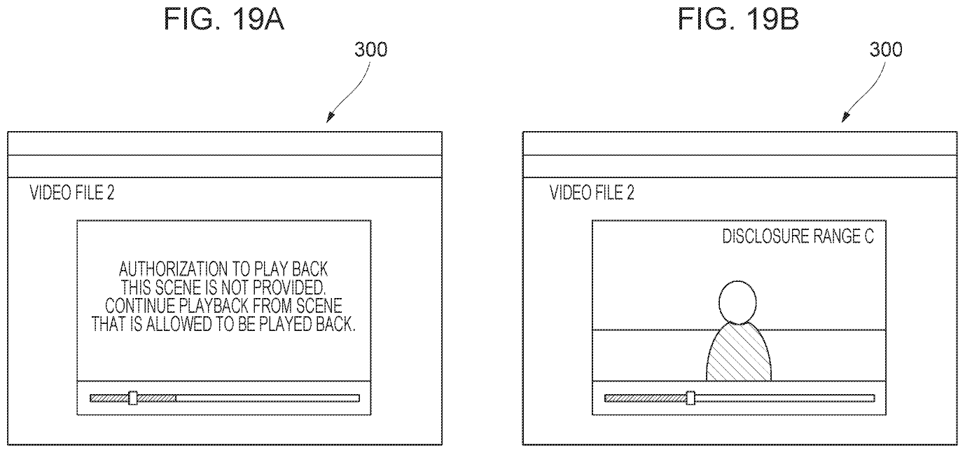

FIGS. 19A and 19B are diagrams illustrating screens displayed when a video file is automatically played back.

In the case where a video file is automatically played back, during a time period for which the video file is not able to be viewed, as illustrated in FIG. 19A, information indicating that a viewer does not have an authorization to play back the video file is displayed.

Furthermore, during the period for which the video file is not able to be viewed, as illustrated in FIG. 19A, information indicating that playback is to start from a time period for which playback is allowed.

In this exemplary embodiment, after the display illustrated in FIG. 19A is performed for a predetermined period of time, as illustrated in FIG. 19B, playback starts from the time period for which playback is allowed.

In other words, playback automatically starts from a permitted part that a user is able to view.

More specifically, to automatically play back a video file, playback of the video file starts from the beginning of the video file.

For example, in the case where a time period for which playback is not allowed exists at the beginning of the video file, as in this exemplary embodiment, information indicating that a viewer does not have an authorization to view the video file and information indicating that playback is to start from the time period for which playback is allowed are displayed, as illustrated in FIG. 19A.

Next, as illustrated in FIG. 19B, playback from the time period for which playback is allowed automatically starts.

In FIGS. 19A and 19B, a processing example in a case where a video file is automatically played back is illustrated. In this processing example, every time that a time period for which the video file is not able to be viewed is reached, information indicating that a viewer does not have an authorization to view the video file and information indicating that playback starts from a time period for which playback is allowed are displayed.

After such display is performed for a predetermined period of time, the processing skips to the time period for which playback is allowed, and playback starts from the time period for which playback is allowed.

Additionally, in the processing example illustrated in FIGS. 19A and 19B, playback control information, which is control information for causing playback of the video file to start from a permitted part of the video file, is generated by the content management server 20.

Accordingly, the client terminal 10 automatically starts to play back the video file from the permitted part.

In other words, in the processing example illustrated in FIGS. 19A and 19B, playback of the video file on the display device 300 on which a viewer performs viewing is controlled on the basis of the playback control information.

As described above, in the case where playback control information for causing playback of a video file to automatically start from a permitted part is generated, playback of the video file automatically starts from the permitted part.

More specifically, in this case, under the control based on the playback control information, playback of the video file automatically starts from the permitted part, without a non-permitted part of the video file being played back.

In the case where a user who belongs to the X department group wishes to view the video file 2, the user is able to play back the video file 2 for a time period from 00:00:00 to 00:07:00.

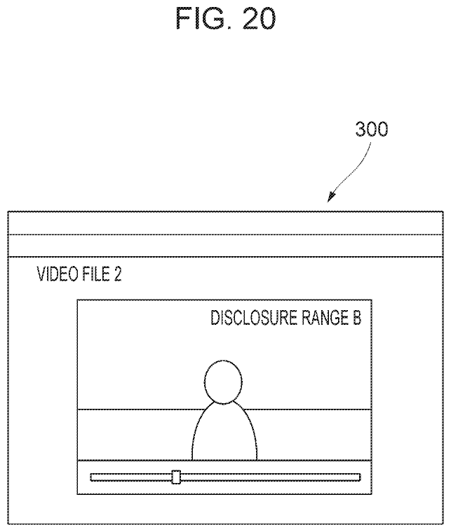

In this case, as illustrated in FIG. 20 (a diagram illustrating another example of display on the client terminal 10), the user who belongs to the X department group is also able to view the video file for a time period from 00:00:00 to 00:02:00. Thus, the user who belongs to the X department group is able to view the whole time period of the video file 2.

In the display example illustrated in FIGS. 19A and 19B, a user is able to know that there is a time period for which the user is not able to view the video file.

However, for example, information indicating that there is a time period for which the user is not able to view the video file may not be displayed. In this case, only a time period for which the user is able to view may be displayed.

### Thumbnail Image and Thumbnail Video

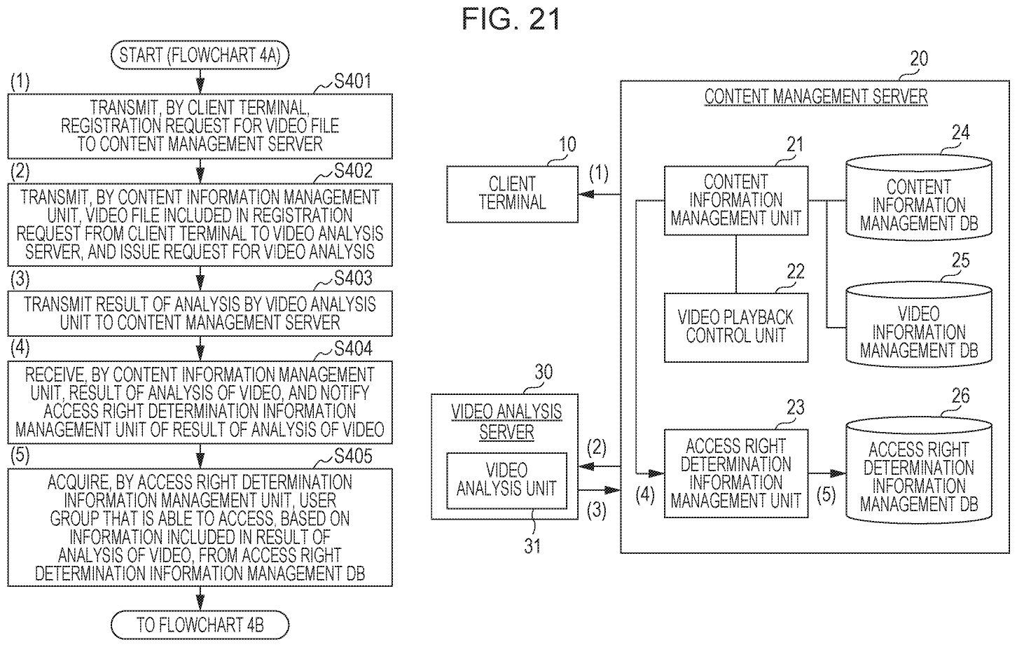

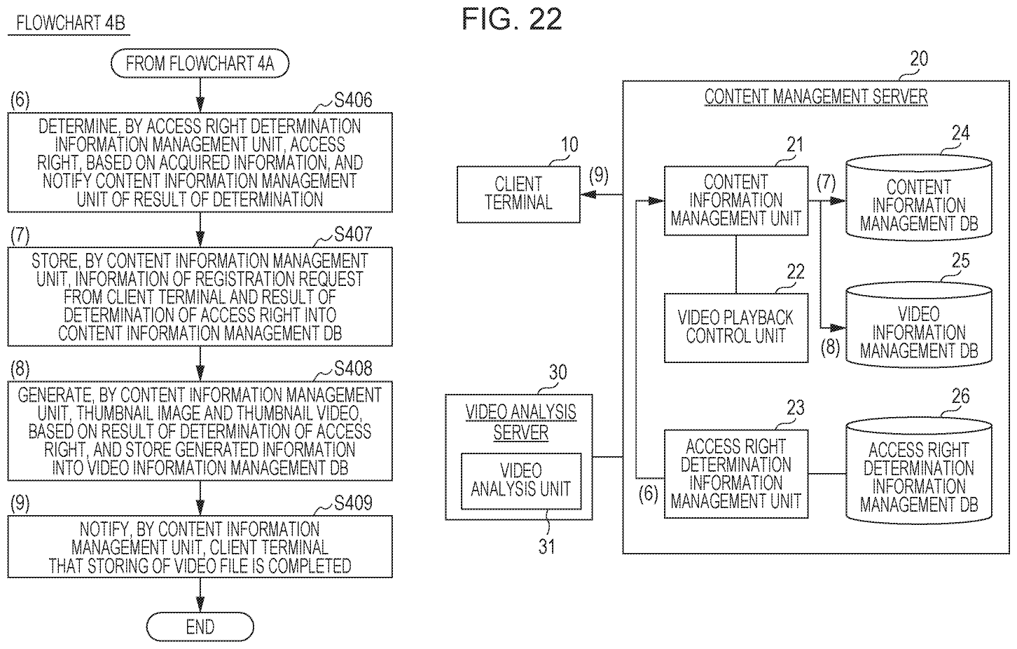

FIGS. 21 and 22 are flowcharts illustrating an example of another process for registering a video file.

Processing of steps S401 to S407 and step S409 in FIGS. 21 and 22 is similar to the processing of steps S101 to S108 (see FIGS. 2 and 3) described above. Explanation for processing of step S408 will be focused on below.

In this process, as described above, the client terminal 10 transmits a request to register a video file to the content management server 20 (step S401).

In this exemplary embodiment, the content management server 20 acquires the registration request. Then, the content information management unit 21 transmits a video file included in the registration request to the video analysis server 30, and requests the video analysis server 30 for analysis of the video file (step S402).

The video analysis server 30 receives the video file, and the video analysis unit 31 analyzes the video file. A result of the analysis obtained by the video analysis unit 31 is transmitted to the content management server 20 (step S403).

The content information management unit 21 receives the analysis result, and notifies the access right determination information management unit 23 of the analysis result (step S404).

The access right determination information management unit 23 acquires information of a user group that is able to access the video file as a registration target, based on the analysis result and information stored in the access right determination information management DB 26 (step S405).

Next, the access right determination information management unit 23 determines an access right, and notifies the content information management unit 21 of a result of the determination (step S406).

The content information management unit 21 stores information of the registration request from the client terminal 10 and the result of determination of the access right into the content information management DB 24 (step S407).

Next, in this exemplary embodiment, the content information management unit 21 generates a thumbnail image and a thumbnail video from the video file as the registration target, based on the determination result of the access right, and stores information of the generated thumbnail image and thumbnail video into the video information management DB 25 (step S408).

In other words, the content information management unit 21 generates a thumbnail image as an example of an image representing part of the video file as the registration target and a thumbnail video as an example of a video representing part of the video file as the registration target.

More specifically, in this exemplary embodiment, as described later, for each viewer who views a video file, a thumbnail image and a thumbnail video are generated.

The term “thumbnail image” represents an image representing part of a target video file. For example, a thumbnail image is generated by selecting part of a plurality of images forming the video file.

Furthermore, the term “thumbnail video” represents a video representing part of a target video file. For example, a thumbnail video is generated by selecting images from a plurality of images forming the video file and arranging the selected images in a sequential manner.

In this exemplary embodiment, a thumbnail image and a thumbnail video are generated. However, both the thumbnail image and thumbnail video are not necessarily generated. Only one of a thumbnail image and a thumbnail video may be generated.

The content information management unit 21 generates the thumbnail image and the thumbnail video as described above, and stores information of storage destinations for the generated thumbnail image and thumbnail video (hereinafter, referred to as “storage destination information”) into the video information management DB 25 (step S408).

Next, the content information management unit 21 notifies the client terminal 10 that storing of the video file is completed (step S409).

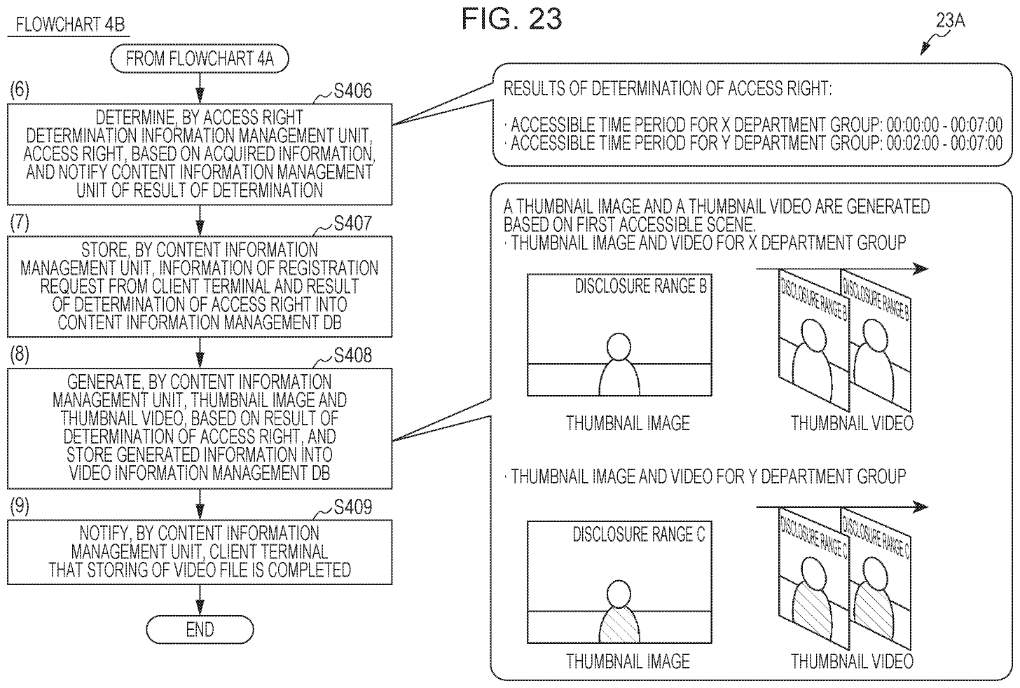

FIG. 23 is a diagram illustrating a specific example of a process for generating a thumbnail image and a thumbnail video.

In this exemplary embodiment, in step 406, as indicated by sign 23A, for example, as a result of determination of the access right for the video file 2, the following information is output:

“accessible time period for X department group: from 00:00:00 to 00:07:00”; and “accessible time period for Y department group: from 00:02:00 to 00:07:00”

Then, in step S407, the above information is stored into the content information management DB 24.

More specifically, in FIG. 23, a case where registration of the video file 2 is performed is illustrated. In step S406, as the result of determination of the access right for the video file 2, the following information is output:

“accessible time period for X department group: from 00:00:00 to 00:07:00”; and

“accessible time period for Y department group: from 00:02:00 to 00:07:00”

Then, in step S407, the above information is stored into the content information management DB 24.

In step S408, the content information management unit 21 generates a thumbnail image and a thumbnail video from the video file 2 as a registration target.

The content information management unit 21 generates a thumbnail image and a thumbnail video based on the result of determination of the access right (the result of determination of the access right stored in the content information management DB 24 (see FIG. 8)) acquired in step S406.

More specifically, in this example, the content information management unit 21 generates a thumbnail image and a thumbnail video corresponding to the user who belongs to the X department group from the time period “from 00:00:00 to 00:07:00” of the video file 2 that the X department group is able to access.

In other words, the content information management unit 21 generates a thumbnail image and a thumbnail video from a permitted part of the video file 2 corresponding to the X department group (a permitted part of the video file 2 that the user in the X department group is permitted to view).

Furthermore, the content information management unit 21 generates a thumbnail image and a thumbnail video corresponding to the user who belongs to the Y department group from the time period “from 00:02:00 to 00:07:00” of the video file 2 that the Y department group is able to access.

In other words, the content information management unit 21 generates a thumbnail image and a thumbnail video from a permitted part of the video file 2 corresponding to the Y department group.

In this exemplary embodiment, as described above, a permitted part of a video file that each viewer is permitted to view is set.

In this exemplary embodiment, a thumbnail image and a thumbnail video are generated for each viewer from the permitted part corresponding to the viewer.

Furthermore, in this exemplary embodiment, a thumbnail image and a thumbnail video are generated by not including a non-permitted part, which is other than a permitted part, of a video file.

In this exemplary embodiment, the generated thumbnail image and thumbnail video are stored in the hard disk drive 102 (see FIG. 28), and storage destination information is stored in the video information management DB 25 in association with a user group.

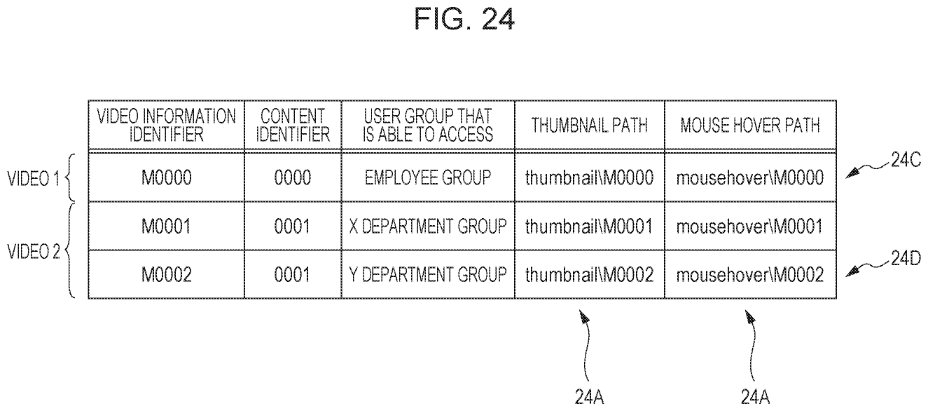

FIG. 24 is a diagram illustrating an example of storage destination information stored in the video information management DB 25.

In this exemplary embodiment, when a request to register a video file is issued, a thumbnail image and a thumbnail video are generated for each user group, as described above.

In this exemplary embodiment, as indicated by sign 24A in FIG. 24, storage destination information indicating a storage destination for the thumbnail image and storage destination information indicating a storage destination for the thumbnail video are registered in association with the user group.

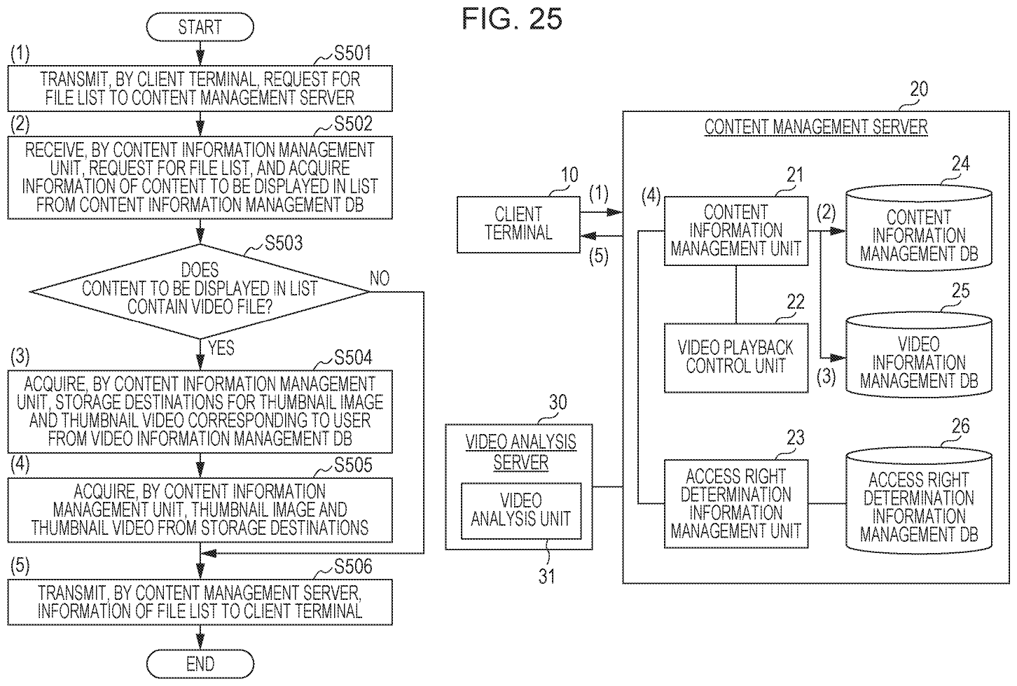

FIG. 25 is a flowchart illustrating the flow of a process for displaying a file list.

Processing of steps S501 to S503 and step S506 in FIG. 25 is similar to the processing of steps S201 to S203 and step S209 (see FIGS. 9 and 10). Explanation for processing of steps S504 and S505 will be focused on below.

In the process for displaying a list of files, the client terminal 10 transmits a request for a file list to the content management server 20 (step S501).

In this exemplary embodiment, the content information management unit 21 receives the request for the file list, and acquires information of content to be displayed in the list from the content information management DB 24 (step S502).

Next, the content management server 20 determines whether the content to be displayed in the list contains a video file (step S503).

In the case where it is determined in step S503 that the content to be displayed in the list contains no video file, the process proceeds to step S506.

In contrast, in the case where it is determined in step S503 that the content to be displayed in the list contains a video file, the content information management unit 21 acquires, for each video file, storage destination information of a thumbnail and storage destination information for a thumbnail video corresponding to a user who has issued the request from the video information management DB 25 (step S504).

Then, the content information management unit 21 acquires the thumbnail image and the thumbnail video from the storage destinations identified by the storage destination information for the video file (step S505).

Next, the content management server 20 transmits information of the file list including the thumbnail image and the thumbnail video to the client terminal 10 (S506).

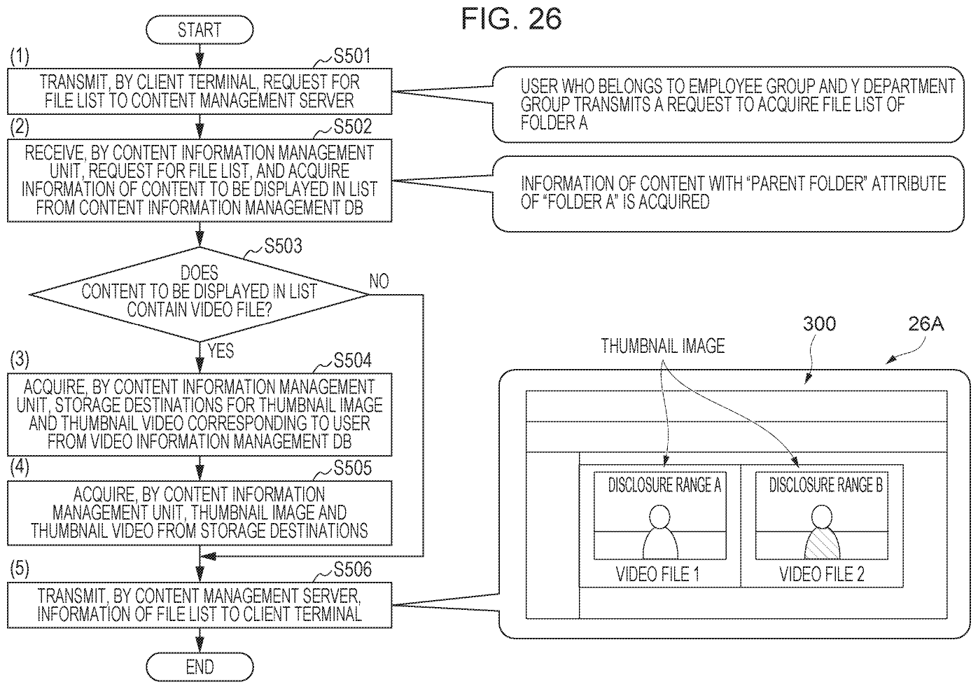

FIG. 26 is a diagram illustrating a specific example of the process for displaying a list of files.

In this example, in step S501, for example, a user who belongs to the employee group and the Y department group transmits a request for a file list of the folder A.

In this case, in step S502, the content information management unit 21 acquires information of content with “parent folder” attribute of “folder A” from the content information management DB 24 (see FIG. 8).

Next, in step S503, it is determined whether the acquired content (content to be displayed in the list) contains a video file.

In the case where it is determined that the acquired content contains no video file, the process proceeds to step 506.

In contrast, in the case where it is determined that the acquired content contains a video file, the process proceeds to step S504.

In step S504, the content information management unit 21 acquires storage destination information of a thumbnail image and a thumbnail video corresponding to the user belonging to the employee group and the Y department group, who has been issued the request, from the video information management DB 25.

Specifically, in this example, the content information management unit 21 acquires storage destination information of a thumbnail image and a thumbnail video for the video file 1, with reference to fields indicated by sign 24C in FIG. 24, from the video information management DB 25.

Furthermore, the content information management unit 21 acquires storage destination information of a thumbnail image and a thumbnail video for the video file 2, with reference to fields indicated by sign 24D in FIG. 24, from the video information management DB 25.

Next, in this exemplary embodiment, the content information management unit 21 acquires a thumbnail image and a thumbnail video for each of the video file 1 and the video file 2 from the storage destinations, based on the storage destination information acquired in the processing of step S504 (see FIG. 26) (step S505).

Then, in this exemplary embodiment, in step S506, the content management server 20 transmits information of the list of files including the thumbnail image and the thumbnail video to the client terminal 10.

Accordingly, in this exemplary embodiment, as indicated by sign 26A in FIG. 26, the thumbnail image (in this display example, a thumbnail video is not illustrated) is displayed.

In this exemplary embodiment, the thumbnail image representing the video file 2 is generated from a permitted part of the video file 2 that the user who belongs to the employee group and the Y department group is permitted to view.

Thus, in this exemplary embodiment, the user who belongs to the employee group and the Y department group is prevented from viewing a non-permitted part in a thumbnail image.

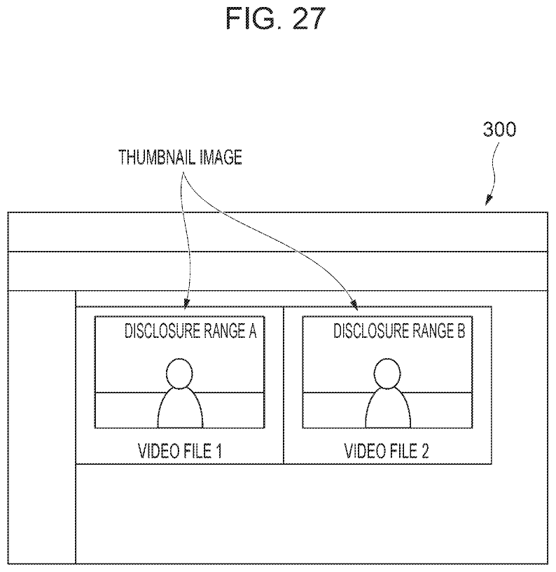

FIG. 27 is a diagram illustrating a screen displayed on the client terminal 10 of a user who belongs to the X department group.

The user who belongs to the X department group is able to view the whole time period of the video file 2. Thus, as illustrated in FIG. 27, a normal thumbnail for the video file 2 is displayed.

In contrast, a non-permitted part of the video file 2 that is not permitted to be viewed is set for a user who belongs to the Y department group. Thus, a thumbnail image and a thumbnail video for the video file 2 generated based on a time period, which is a permitted part that is permitted to be viewed, are displayed for the user who belongs to the Y department group.

In this case, different thumbnail images and different thumbnail videos for the video file 2 are displayed for the user who belongs to the X department group and the user who belongs to the Y department group.

In this exemplary embodiment, when a thumbnail image or a thumbnail video displayed on the client terminal 10 is selected by a user, the process for playing back a video illustrated in FIGS. 16 and 17 is performed.

In this case, for example, in the case where the video file 2 is selected by the user who belongs to the Y department group and playback of the video file 2 is performed, a time period “from 00:02:00 to 00:07:00” of the video file 2 is played back. That is, a permitted part of the video file 2 is played back.

Furthermore, for example, in the case where the video file 2 is selected by the user who belongs to the X department group and playback of the video file 2 is performed, a time period “from 00:00:00 to 00:07:00” of the video file 2 is played back. That is, the whole time period of the video file 2 is played back.

In this exemplary embodiment, the content information management unit 21 generates a thumbnail image and a thumbnail video corresponding to the X department group such that a specific scene in a permitted part is included in the thumbnail image and the thumbnail video.

More specifically, the content information management unit 21 generates a thumbnail image and a thumbnail video such that, for example, the first scene of a permitted part is included in the thumbnail image and the thumbnail video.

More specifically, for the user who belongs to the X department group, the whole time period of the video file 2 is set as the permitted part of the video file 2.

In this case, the content information management unit 21 generates a thumbnail image and a thumbnail video such that the first scene present in the first part of the whole time period is included in the thumbnail image and the thumbnail video.

More specifically, a thumbnail image and a thumbnail video are generated such that the first scene in the time period “from 00:00:00 to 00:07:00” is included in the thumbnail image and the thumbnail video.

The content information management unit 21 also generates a thumbnail image and a thumbnail video corresponding to the Y department group such that a specific scene in a permitted part is included in the thumbnail image and the thumbnail video.

More specifically, the content information management unit 21 generates a thumbnail image and a thumbnail video such that, for example, the first scene in the permitted part is included in the thumbnail image and the thumbnail video.

More specifically, for the user who belongs to the Y department group, a time period “from 00:02:00 to 00:07:00” of the video file 2 is set as a permitted part of the video file 2.

In this case, a thumbnail image and a thumbnail video are generated such that the first scene in the time period “00:02:00 to 00:07:00” is included in the thumbnail image and the thumbnail video.

Furthermore, a thumbnail image and a thumbnail video may be generated from a different position of a permitted part. For example, an image may be extracted from a permitted part for every certain period of time, and the extracted images may be arranged in a sequential manner to generate a thumbnail video.

Furthermore, for example, an image may be extracted from the final position in a permitted part, and a thumbnail image and a thumbnail video may be generated based on the extracted image.

Furthermore, in the case where a video includes a plurality of permitted parts, at least one image may be extracted from each of the permitted parts, and the extracted images may be arranged in a sequential manner to generate a thumbnail video.

In the embodiments above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing system comprising:
a processor configured to
acquire information included in a video and/or information attached to the video,
determine, for each viewer who views the video, a permitted part of the video that the viewer is permitted to view, based on the acquired information, and
generate, for the viewer, control information for causing the permitted part corresponding to the viewer to be played back.

2. The information processing system according to claim 1, wherein the processor generates the control information for causing the permitted part corresponding to the viewer to be played back and causing a part other than the permitted part not to be played back.

3. The information processing system according to claim 1,
wherein the permitted part of the video is displayed on a display device on which the viewer performs viewing, and
wherein in a case where the permitted part is part of the video, the processor further generates control information for causing information indicating that the part of the video will not be displayed to be displayed on the display device.

4. The information processing system according to claim 1,
wherein the permitted part of the video is displayed on a display device on which the viewer performs viewing, and
wherein the processor further generates control information for causing predetermined information to be displayed on the display device in a case where playback of a non-permitted part of the video that is a part other than the permitted part is requested by the viewer.

5. The information processing system according to claim 4, wherein the predetermined information to be displayed on the display device includes information indicating that playback of the video is not allowed.

6. The information processing system according to claim 1,
wherein the permitted part of the video is displayed on a display device on which the viewer performs viewing, and
wherein the processor further generates display control information for causing non-authorization information indicating that the viewer does not have an authorization to play back a non-permitted part of the video that is a part other than the permitted part to be displayed on the display device.

7. The information processing system according to claim 6, wherein the processor generates the display control information for causing the non-authorization information to be displayed on the display device in a case where playback of the non-permitted part is requested by the viewer.

8. The information processing system according to claim 1, wherein the processor further generates playback control information for causing playback of the video to start from the permitted part of the video.

9. The information processing system according to claim 8,
wherein playback of the video on the display device on which the viewer performs viewing is controlled based on the playback control information, and
wherein in a case where playback of a non-permitted part of the video that is a part other than the permitted part is requested by the viewer, the video starts from the permitted part under control based on the playback control information.

10. The information processing system according to claim 1,
wherein the processor generates a screen that the viewer views, an image corresponding to the video being displayed on the screen, and
wherein the image corresponding to the video varies according to a length of the permitted part of the video.

11. The information processing system according to claim 10,
wherein, when displaying an image corresponding to a video in which part of a whole time period of the video is defined as the permitted part on the screen, the processor displays the image corresponding to the video in a first display mode, and
wherein, when displaying an image corresponding to a video in which the whole time period of the video is defined as the permitted part on the screen, the processor displays the image corresponding to the video in a second display mode that is different from the first display mode.

12. An information processing apparatus comprising:
a processor configured to
acquire information included in a video and/or information attached to the video,
determine, for each viewer who views the video, a permitted part of the video that the viewer is permitted to view, based on the acquired information, and
generate, for the viewer, control information for causing the permitted part corresponding to the viewer to be played back.

13. A non-transitory computer readable medium storing a program causing a computer to execute a process for information processing, the process comprising:
acquiring information included in a video and/or information attached to the video,
determining, for each viewer who views the video, a permitted part of the video that the viewer is permitted to view, based on the acquired information, and
generating, for the viewer, control information for causing the permitted part corresponding to the viewer to be played back.
